(19) United States
(12) Patent Application Publication
(10) Pub. No.: US 2005/0007439 A1
(43) Pub. Date: Jan. 13, 2005

(54) Thermal printer adapted to shorten a fixing time

(75) Inventors: Koichi Hirasawa, Saitawa (JP); Katsuya Inana, Saitama (JP); Seisuke Muroki, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/886,680

(22) Filed: Jul. 9, 2004

(30) Foreign Application Priority Data
Jul. 9, 2003 (JP) 2003-194570

(51) Int. Cl. B41J 2/315

(52) U.S. Cl. 347/212

(57) ABSTRACT

A magenta fixing unit comprises an ultraviolet lamp and a reflector. The ultraviolet lamp is set in a width direction of a color thermosensitive recording paper. The reflector is disposed so as to cover the ultraviolet lamp. The fixing unit is structured such that the center of the ultraviolet lamp is near to a left edge of the reflector rather than a right edge thereof. By this structure, illuminance is heightened at a left side of a fixation area in comparison with a conventional fixing unit. When using the ultraviolet lamp having conventional light intensity, ultraviolet rays of a lager amount are radiated to an end portion of a record area at the time of stop fixation, in comparison with the conventional one. Time to be taken for the stop fixation is shortened.

### BACKGROUND OF THE INVENTION

1. Field of the Invention

The present invention relates to a thermal printer, and in particular to a thermal printer adapted to shorten a fixing time.

2. Description of the Related Art

There is a well-known color thermal printer in which a full-color image is printed by using a color thermosensitive recording paper, which has at least three kinds of thermosensitive coloring layers formed on a support in order. The thermosensitive coloring layers are cyan, magenta and yellow thermosensitive coloring layers, for example.

When printing is performed in the color thermal printer, a thermal head is pressed against the color thermosensitive recording paper and is heated in accordance with print data to color the respective thermosensitive coloring layers. Concretely, a yellow image is thermally recorded one line by one line in the yellow thermosensitive coloring layer having the highest heat sensitivity, and just after that, the yellow thermosensitive coloring layer is fixed. Successively, a magenta image is thermally recorded in the magenta thermosensitive coloring layer, and then, this layer is fixed. Lastly, a cyan image is thermally recorded in the cyan thermosensitive coloring layer to obtain a full-color image.

A fixing unit contained in the printer is used for fixing the yellow and magenta thermosensitive coloring layers. In general, the fixing unit comprises two kinds of rod-shaped ultraviolet lamps and a reflector disposed behind them, such as described in Japanese Patent Laid-Open Publication Nos. 8-118689 and 2001-246768. The ultraviolet lamps are for the yellow and magenta thermosensitive coloring layers. Ultraviolet lays having specific wavelength bands are radiated to the respective thermosensitive coloring layers to perform fixation. Incidentally, heat sensitivity of the cyan thermosensitive coloring layer is of a level at which coloring is not caused in an ordinary usage condition of the printer. Thus, it is regarded that fixing properties are not given to this layer.

As to methods for fixing the color thermosensitive recording paper with the fixing unit, there are typical methods of a passage fixing method and a stop fixing method. In the passage fixing method, the color thermosensitive recording paper is carried so as to pass the fixing unit at a constant speed. While carrying the recording paper, the ultraviolet rays are radiated to fix the corresponding thermosensitive coloring layer. Meanwhile, in some cases, fixation is performed under control of the carrying speed in order to radiate the ultraviolet rays of a constant amount to all of a record area of the color thermosensitive recording paper. When the passage fixing method is adopted for a strip of the color thermosensitive paper, a shutter plate is used. The shutter plate is moved in synchronism with the recording paper to shield this recording paper from the fixing lamp. When an end portion of the leading record area passes a fixation area, the shutter plate shields the record area to be printed next, from the fixing unit to prevent the next record area from being fixed. In the passage fixing method, it is possible to radiate the ultraviolet rays of the constant radiation amount to the whole record area of the recording paper. Thus, the passage fixing method is adopted for the fixation of the yellow thermosensitive coloring layer having problems of excessive fixing and insufficient fixing.

In the stop fixing method, carrying the color thermosensitive recording paper is stopped at a position confronting the fixing unit, and the ultraviolet rays are radiated during a predetermined period to fix the thermosensitive coloring layer. As for the actual color thermal printer, a length of the record area in a carrying direction of the recording paper is longer than the fixation area of the fixing unit. Consequently, it is partially performed as passage fixation to radiate the ultraviolet rays in the state that the recording paper is carried. Carrying the recording paper is stopped at a position where the end portion of the leading record area confronts the fixing unit, in other words, at a position where a head portion of the next record area avoids confronting the fixing unit. And then, it is performed as stop fixation to radiate the ultraviolet rays during a predetermined period to make the radiation amount equal to that of the other region for which the passage fixation has been already performed. The stop fixing method is adopted for the fixation of the magenta thermosensitive coloring layer, because the cyan thermosensitive coloring layer to be thermally recorded next is not affected even if the ultraviolet rays of a prescribed amount or more are radiated.

The stop fixing method takes a time for fixing the thermosensitive coloring layer in comparison with the passage fixing method. This is caused by that an ultraviolet-ray radiation area of the fixing unit, which is conventionally used, has different illuminance in a sub-scanning direction perpendicular to a scanning direction. Both side portions of the radiation area in the sub-scanning direction have lower illuminance in comparison with a central portion thereof. Such as shown in FIG. 6A, a low-illuminance area widely exists in a side portion of a fixation area of the conventional fixing unit rather than a central portion of the fixation area. For perfectly fixing the whole record area of the recording paper by using the stop fixing method, it is necessary to perfectly fix the portion confronting the low-illuminance area. Thus, there arises a problem in that the stop fixation takes longer time.

In order to solve the above problem, it is considered to reduce the low-illuminance area by downsizing a reflector such as shown in FIG. 6B. In this case, however, the ultraviolet rays emitted from the ultraviolet lamp are more likely to cause interference inside the reflector so that a total amount of the ultraviolet rays to be radiated toward the recording paper is reduced. Thus, also in this case, it takes a longer fixing time.

### SUMMARY OF THE INVENTION

In view of the foregoing, it is a primary object of the present invention to provide a thermal printer in which a fixing time is shortened.

In order to achieve the above and other objects, the thermal printer according to the present invention comprises a thermal head and a fixing unit. The thermal head performs thermal recording on a record area of a thermosensitive recording paper while this recording paper is fed by a feeder in a first direction. The fixing unit fixes a thermosensitive coloring layer of the recording paper by radiating electromagnetic rays to the record area while the recording paper is fed by the feeder in a second direction after thermal recording. The fixing unit is structured such that illuminance of the electromagnetic rays is higher at a near side to the thermal head in comparison with a far side thereof.

The thermal printer further comprises a controller for controlling the feeder. The controller stops the recording paper, during fixation of the thermosensitive coloring layer, at a position where an end portion of the record area confronts the fixing unit. The electromagnetic rays are radiated to the end portion of the record area until a radiation amount of the electromagnetic rays of the end portion becomes equal to that of a portion of the thermosensitive recording paper, which has already passed the fixing unit.

In a preferred embodiment, the fixing unit is constituted of a rod-shaped ultraviolet lamp and a reflector for covering the ultraviolet lamp. The reflector has a prescribed open area. A center position of the ultraviolet lamp is biased toward the upstream side from a center position of the open area of the reflector. Alternatively, the fixing unit comprises a plurality of light emitting elements arranged in matrix. The light-emitting elements have higher density at the upstream side rather than the downstream side.

According to the thermal printer of the present invention, in comparison with the conventional one, the electromagnetic rays of a lager amount are radiated to the end portion of the record area at the time of stop fixation. Thus, a period for the stop fixation is adapted to be shortened.

### BRIEF DESCRIPTION OF THE DRAWINGS

The above objects and advantages of the present invention will become apparent from the following detailed description of the preferred embodiments of the invention when read in conjunction with the accompanying drawings, in which:

FIG. 1 is a schematic illustration showing a structure of a color thermal printer according to the present invention;

FIG. 2 is an explanatory illustration showing a record area of a color thermosensitive recording paper;

FIG. 3 is an explanatory illustration showing a structure of a magenta fixing unit according to the present invention;

FIG. 4 is a flowchart showing an operation procedure to be executed at the time of printing;

FIG. 5 is an explanatory illustration showing a structure of a magenta fixing unit of another embodiment; and

FIGS. 6A and 6B are explanatory illustrations respectively showing a structure of a conventional fixing unit.

### DETAILED DESCRIPTION OF THE PREFERRED EMBODIMENT(S)

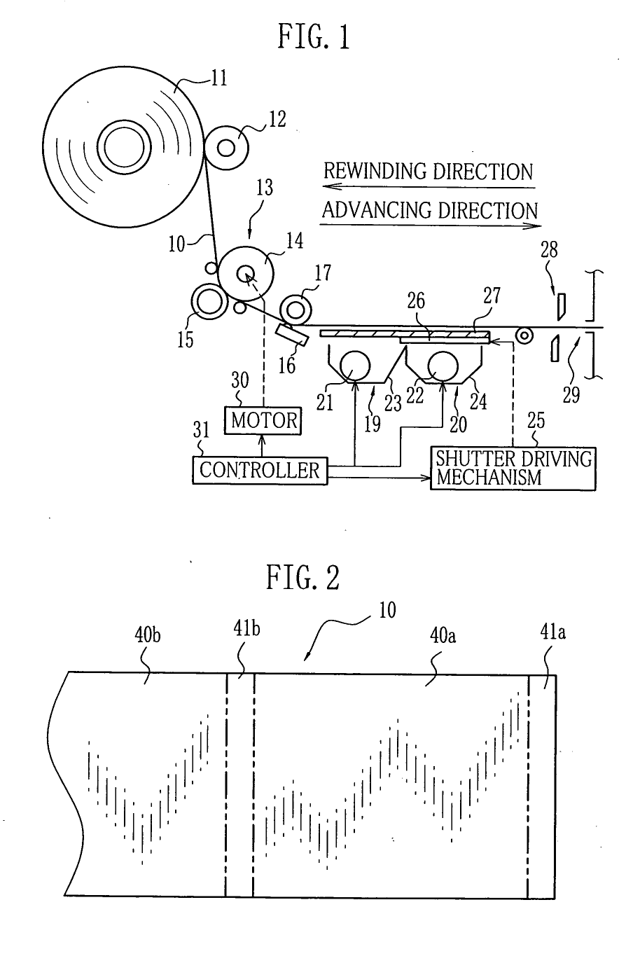

FIG. 1 is a schematic illustration showing a structure of a color thermal printer according to the present invention. The thermal printer uses a strip of a color thermosensitive recording paper 10 as a recording medium. The recording paper 10 is set to the color thermal printer in a state of a recording-paper roll 11 wound in roll form.

A paper roller 12 abuts on the periphery of the recording-paper roll 11. The paper roller 12 is rotated in both directions by a motor (not shown), and rotates the abutting paper roll 11 to advance and rewind the recording paper 10.

Near the recording-paper roll 11, a feeding roller pair 13 for nipping and feeding the recording paper 10 is disposed at a downstream side in an advancing direction of the recording paper 10. The feeding roller pair 13 comprises a capstan roller 14 rotated by a motor 30, and a nip roller 15 pressed against the capstan roller 14. The feeding roller pair 13 reciprocates the recording paper 10 in the advancing direction and a rewinding direction, which are right and left directions respectively in the drawing. The motor 30 is controlled by a controller 31. In other words, the capstan roller 14 is controlled by the controller 31 via the motor 30.

As well known, the recording paper 10 comprises cyan, magenta and yellow thermosensitive coloring layers formed on a support in order. The yellow thermosensitive coloring layer is the uppermost layer and has the highest heat sensitivity to color in yellow by small heat energy. The cyan thermosensitive coloring layer is the lowermost layer and has the lowest heat sensitivity to color in cyan by great heat energy. Incidentally, the yellow thermosensitive coloring layer loses it coloring ability upon radiating the near ultraviolet rays of 420 nm. The magenta thermosensitive coloring layer is the second thermosensitive coloring layer and colors in magenta by intermediate heat energy ranked between those of the yellow and cyan thermosensitive coloring layers. The magenta thermosensitive coloring layer loses its coloring ability upon radiating the ultraviolet rays of 365 nm. The recording paper 10 may have a four-layer construction additionally including a black thermosensitive coloring layer.

As shown in FIG. 2, the recording paper 10 is provided with recording areas 40a, 40b and so forth defined at predetermined intervals from a leading side. Margins 41a, 41b and so forth are provided between the recording areas 40a, 40b and so forth as need arises. Printing and fixing of the recording paper 10 are performed for the respective recording areas 40a, 40b and so forth. Incidentally, printing is performed in a frame sequential manner such as described later.

At a downstream side of the feeding roller pair 13 in the advancing direction, a thermal head 16 and a platen roller 17 are disposed so as to interpose a passage of the recording paper 10. The thermal head 16 is disposed under the passage of the recording paper 10, and includes a large number of heating elements aligned in a scanning direction perpendicular to a feeding direction of the recording paper. The platen roller 17 is disposed at an opposite position of the thermal head 16 and above the passage of the recording paper. Further, the thermal head 16 is movable in a vertical direction and is urged by a spring, which is not shown, in a pressing direction against the platen roller 17.

The thermal head 16 is pressed against the recording paper 10 fed by the feeding roller pair 13. The thermal head 16 heats the aligned heating elements up to a predetermined temperature to color the respective thermosensitive coloring layers. The platen roller 17 is rotated in association with feeding of the recording paper 10 to assist the recording paper 10 in contacting with the heating elements.

At a downstream side of the thermal head 16 in the advancing direction, magenta and yellow fixing units 19 and 20 are disposed so as to confront a record surface of the recording paper 10.

The magenta and yellow fixing units 19 and 20 comprise ultraviolet lamps 21 and 22 set in a width direction of the recording paper 10, and reflectors 23 and 24 covering the ultraviolet lamps 21 and 22. The ultraviolet lamp 21 of the magenta fixing unit 19 emits the ultraviolet rays whose luminous peak is 365 nm to fix the magenta thermosensitive coloring layer of the recording paper 10. The ultraviolet lamp 22 of the yellow fixing unit 20 emits the near ultraviolet rays whose luminous peak is 420 nm to fix the yellow thermosensitive coloring layer. The reflectors 23 and 24 reflect the ultraviolet rays, which are emitted from the respective ultraviolet lamps 21 and 22, toward the recording paper 10. Widths of the reflectors 23 and 24 define a fixation area for fixing the thermosensitive coloring layer.

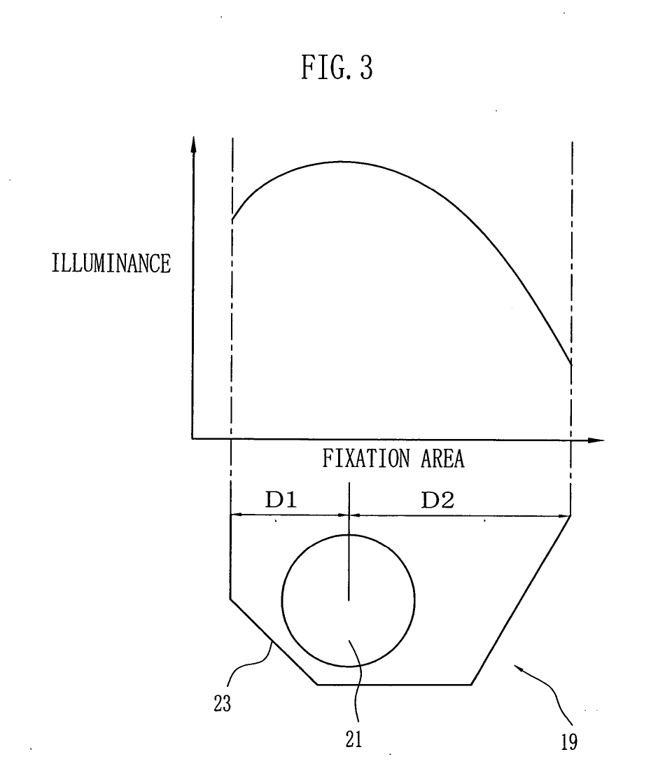

As shown in FIG. 3, the magenta fixing lamp 19 is structured such that a distance D1 is shorter than a distance D2, wherein the distance D1 is from the center of the ultraviolet lamp 21 to a left end of the reflector 23, and the distance D2 is from the center of the ultraviolet lamp 21 to a right end of the reflector 23. In virtue of this structure, such as shown by a graph in the drawing, illuminance of a left side of the fixation area increases in comparison with a conventional one. Thus, when using the ultraviolet lamp having prior luminous strength, it is possible to radiate a grater amount of the ultraviolet rays to the end portion of the record area at the time of stop fixation. Consequently, a stop fixing time is shortened. Moreover, since it is possible to obtain a sufficient opening width of the reflector 23, an interference ratio of the ultraviolet rays emitted from the ultraviolet lamp 21 is prevented from increasing in the reflector 23. It is possible to fully secure a total amount of the ultraviolet rays to be radiated toward the recording paper 10.

Above the magenta and yellow fixing units 19 and 20, is disposed a shutter plate 26 formed from a material blocking off the ultraviolet rays emitted from the yellow fixing unit 20. The shutter plate 26 is moved by a shutter driving mechanism 25 between a block position where the recording paper 10 is concealed from the yellow fixing unit 20, and an open position where the recording paper 10 is opened to the yellow fixing unit 20.

A paper guide 27 formed from a material transmitting the ultraviolet rays, for example an acryl plate, is disposed above a movement space of the shutter plate 26. The paper guide 27 guides the recording paper 10, and at the same time, transmits the ultraviolet rays toward the recording paper 10.

A cutter 28 for cutting the strip of the recording paper 10 into the respective record areas is disposed at a downstream side of the yellow fixing unit 20 in the advancing direction. A paper outlet 29 is formed at a downstream side of the cutter 28 to discharge the recording paper 10, which is printed and cut, to the outside of the printer.

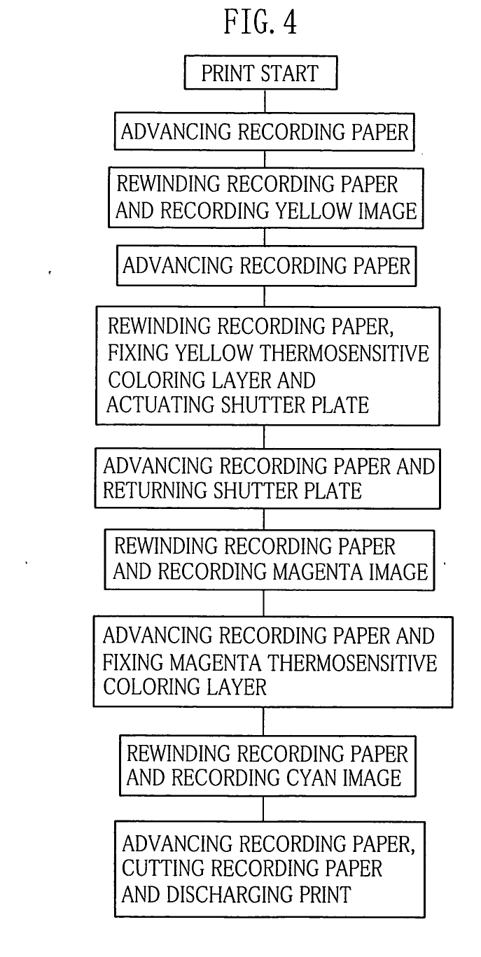

Next, an operation of the above embodiment is described below, referring to a flowchart shown in FIG. 4. When a printing operation is started in the color thermal printer, the paper roller 12 is rotated by the motor in a counterclockwise direction. Upon this, the recording-paper roll 11 is rotated in a clockwise direction to advance the recording paper 10 from the recording-paper roll 11.

The recording paper 10 carried in the advancing direction reaches a place positioned between the capstan roller 14 and the nip roller 15. At this time, the paper roller 12 stops to carry the recording paper 10 for the present. After that, the niproller 15 is pressed against the capstan roller 14 to nip the recording paper 10.

The feeding roller pair 13 is rotated by the motor to carry the recording paper 10 in the advancing direction. When the recording paper 10 is carried in the advancing direction by a length of one record area relative to the thermal head 16, the feeding roller pair 13 stops to carry the recording paper 10. Successively, the thermal head 16 moves upward to nip the recording paper 10 with the platen roller 17.

After that, the feeding roller pair 13 carries the recording paper 10 in the rewinding direction. The leading record area 40a of the recording paper 10 is reversed, and a head edge thereof in the rewinding direction reaches the thermal head 16. At this moment, the thermal head 16 starts to thermally record a yellow image on the yellow thermosensitive coloring layer.

After the yellow image has been thermally recorded, the feeding roller pair 13 stops to carry the recording paper in the rewinding direction, and the thermal head 16 moves downward to release the recording paper 10 from being nipped. The feeding roller pair 13 carries the recording paper 10 in the advancing direction again.

The leading record area 40a of the recording paper 10 is advanced, and the head edge thereof in the rewinding direction reaches a front edge of the fixation area of the yellow fixing unit 20, wherein the front edge of the fixation area means the leading edge thereof in the advancing direction. At this moment, the feeding roller pair 13 stops to carry the recording paper in the advancing direction. After that, the feeding rollerpair 13 carries the recording paper 10 in the rewinding direction again. During this carriage, the ultraviolet lamp 22 for yellow is turned on to perform passage fixation for the yellow thermosensitive coloring layer of the leading record area 40a.

While the passage fixation is performed, the shutter driving mechanism is actuated to move the shutter plate 26 of the block position in the rewinding direction at the same speed with the recording paper 10. In virtue of this, it is possible to make the whole of the leading record area 40a pass the ultraviolet lamp 22 without fixing the next record area 40b. Further, it is possible to properly fix the yellow thermosensitive coloring layer by radiating the ultraviolet rays of a regular amount.

After fixing the yellow thermosensitive coloring layer, the feeding roller pair 13 carries the recording paper 10 in the advancing direction again. At this time, the shutter plate 26 set to the open position is restored to the block position by the shutter driving mechanism. Upon carrying the recording paper 10 in the advancing direction by the length of one record area relative to the thermal head 16, the feeding roller pair 13 temporarily stops to carry the recording paper 10. Then, the thermal head 16 moves upward to interpose the recording paper 10 with the platen roller 17.

After that, the feeding roller pair 13 carries the recording paper 10 in the rewinding direction. When the head edge of the leading record area 40a in the rewinding direction reaches the thermal head 16, it is started to thermally record a magenta image on the magenta thermosensitive coloring layer with the thermal head 16.

Upon finishing the thermal record of the magenta image, the feeding roller pair 13 stops to carry the recording paper 10 in the rewinding direction. And then, the thermal head 16 moves downward to release the recording paper 10. The feeding roller pair 13 carries the recording paper 10 in the advancing direction. At the same time, the ultraviolet lamp 21 for magenta is turned on.

When the end edge of the record area 40a in the advancing direction has reached the fixation area of the magenta fixing unit 19, carrying the recording paper 10 is stopped. And then, the stop fixation is performed for the end edge of the record area 40a, where an integrated radiation amount of the ultraviolet rays is smallest, so as to obtain an equivalent of the radiation amount integrated on the other portion for which the passage fixation has been performed.

The magenta fixing unit 19 is structured such that an end side of the fixation area thereof in the advancing direction has higher illuminance rather than the conventional one. Consequently, in comparison with the conventional one, the ultraviolet rays of a larger amount are radiated to an opposite end side of the record area 40a. Thus, it is possible to shorten a time to be taken for the stop fixation.

After fixing the magenta thermosensitive coloring layer, the feeding roller pair 13 carries the recording paper 10 in the rewinding direction. When the head edge of the record area 40a in the rewinding direction has reached the thermal head 16, carrying the recording paper 10 is stopped. And then, the thermal head 16 is moved upward to interpose the recording paper 10 with the platen roller 17. Successively, the feeding roller pair 13 carries the recording paper 10 in the rewinding direction. The thermal head 16 thermally records a cyan image on the cyan thermosensitive coloring layer.

After the cyan image has been thermally recorded, the thermal head 16 is moved downward. Then, the feeding roller pair 13 carries the recording paper 10 in the advancing direction. During this carriage, the cutter 28 cuts both edges of the record area 40a of the recording paper 10 to produce a sheet-form color print whose margin 41a is cut off. The produced color print is discharged from the paper outlet 29.

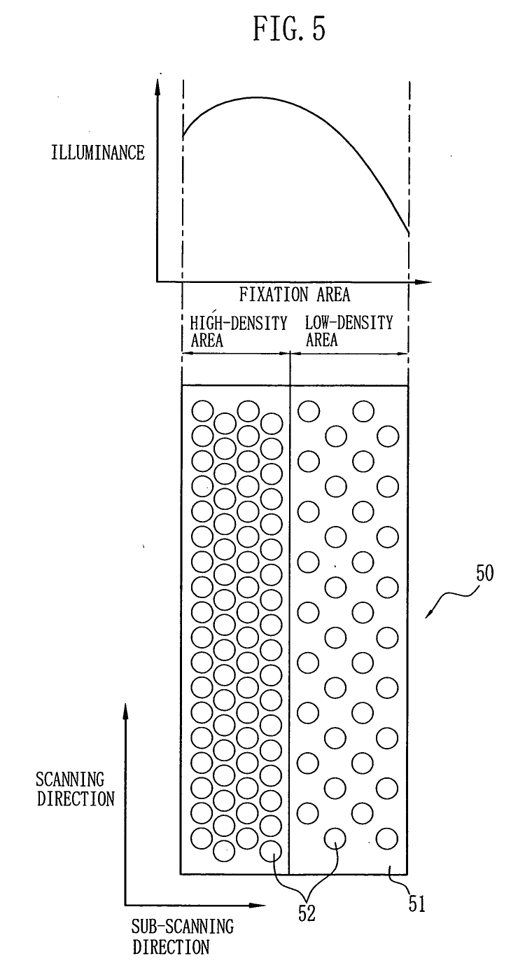

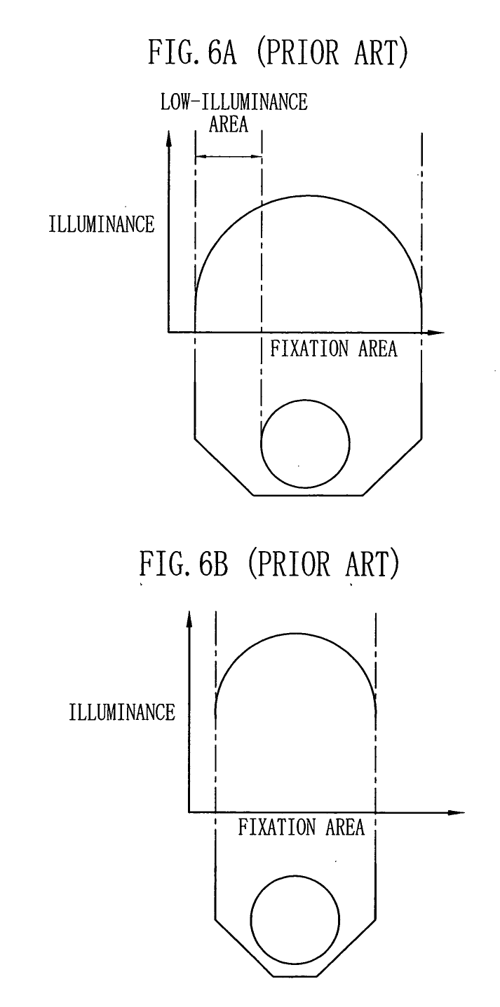

In the above embodiment, the used fixing unit is constituted of the ultraviolet lamp and the reflector. However, an LED may be used as the fixing light source instead of the ultraviolet lamp. In this case, such as shown in FIG. 5 for example, a magenta fixing unit 50 is constituted of a base plate 51 and LEDs 52 for magenta. The LEDs 52 are arranged on the base plate 51 along plural rows and lines extending in a scanning direction and a sub-scanning direction perpendicular to the scanning direction. In FIG. 5, arrangement density of the LEDs 52 is higher at a left side rather than a right side in the sub-scanning direction. By this structure, it is possible to heighten the illuminance of the left side of the fixation area. Thus, when using the LEDs 52 whose number is same with the conventional one, it is possible to radiate the ultraviolet rays of a larger amount, in comparison with the conventional one, to the end portion of the record area at the time of the stop fixation. Consequently, a time to be taken for the stop fixation may be shortened.

Moreover, in the above embodiment, the structure of the fixing unit according to the present invention is only adopted to the magenta fixing unit. However, the yellow fixing unit may have the same structure with the magenta fixing unit. In doing so, the yellow and magenta fixing units can utilize common parts.

Further, in the above embodiment, the color thermal printer uses the strip of the color thermosensitive recording paper and produces the sheet-form color print by cutting the strip after printing. The present invention, however, may be adopted to another color thermal printer in which sheet-form recording papers are successively carried to perform printing. Moreover, the present invention maybe adopted to the other color thermal printer in which the recording paper is wound around a large-size platen drum to perform thermal recording. Further, the present invention may be adopted to a thermal printer using a monochrome thermosensitive recording paper having optical fixation properties.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A thermal printer comprising:
a feeder for reciprocatively feeding a strip of a thermosensitive recording paper having thermosensitive coloring layers to be fixed by reacting to specific electromagnetic rays;
a thermal head for performing thermal recording on a record area while said thermosensitive recording paper is fed, said thermal head being disposed in a scanning direction perpendicular to a feeding direction of said thermosensitive recording paper;
a fixing unit for fixing said thermosensitive coloring layer by radiating the electromagnetic rays to said record area while said thermosensitive recording paper is fed after thermal recording, said fixing unit being structured such that illuminance of the electromagnetic rays is higher at a near side to said thermal head in comparison with a far side thereof; and
a controller for controlling said feeder, said controller stopping said thermosensitive recording paper, during fixation of said thermosensitive coloring layer, at a position where an end portion of said record area confronts said fixing unit, and the electromagnetic rays being radiated to the end portion of said record area until a radiation amount of the electromagnetic rays of the end portion becomes equal to that of a portion of the thermosensitive recording paper, which has already passed said fixing unit.

2. A thermal printer according to claim 1, wherein said fixing unit comprises a rod-shaped ultraviolet lamp and a reflector covering said ultraviolet lamp and having a prescribed open area, a center position of said ultraviolet lamp is biased toward said near side to said thermal head from a center position of said open area of said reflector.

3. A thermal printer according to claim 1, wherein said fixing unit comprises a plurality of light-emitting elements arranged in lines and rows extending in said scanning direction and said feeding direction, said light-emitting elements having higher density at said near side to said thermal head in comparison with said far side thereof.

4. A thermal printer according to claim 3, wherein said light-emitting element is an LED.

5. A thermal printer for frame-sequentially printing an image within a record area of a thermosensitive recording paper having first through third thermosensitive coloring layers of different colors, which are formed in order from a surface, said first thermosensitive coloring layer being fixed by electromagnetic rays of a first wavelength band and said second thermosensitive coloring layer being fixed by electromagnetic rays of a second wavelength band, said thermal printer including:
feed device for feeding said thermosensitive recording paper in a first direction and in a second direction, which is opposite to the first direction, alternately;
a thermal head for performing recording one line by one line from an end of said record area relative to one of said first through third thermosensitive coloring layers while said thermosensitive recording paper is fed in the first direction;
a first fixing unit for fixing said first thermosensitive coloring layer by radiating the electromagnetic rays of said first wavelength band to said record area while said thermosensitive recording paper is fed after the recording of said first thermosensitive coloring layer;
a second fixing unit for fixing said second thermosensitive coloring layer by radiating the electromagnetic rays of said second wavelength band to said record area while said thermosensitive recording paper is fed in the second direction after the recording of said second thermosensitive coloring layer and while said thermosensitive recording paper stops in a state that said second fixing unit confronts an end portion of said record area, said second fixing unit having higher illuminance of the electromagnetic rays at an upstream side rather than a downstream side in the second direction.

6. A thermal printer according to claim 5, wherein said second direction is a direction for drawing said thermosensitive recording paper out of a recording-paper roll, and a feeding roller pair being as said feeding device, said thermal head, said second fixing unit, and said first fixing unit are disposed in said second direction.

7. A thermal printer according to claim 6, further including a controller for controlling said feed device, said controller executing the steps of:
a first step for feeding said thermosensitive recording paper in the second direction;
a second step for feeding said thermosensitive recording paper in the first direction in order to perform recording of said first thermosensitive coloring layer with said thermal head;
a third step for feeding said thermosensitive recording paper in the second direction;
a forth step for feeding said thermosensitive recording paper in the first direction in order to fix said first thermosensitive coloring layer with said first fixing unit;
a fifth step for feeding said thermosensitive recording paper in the second direction;
a sixth step for feeding said thermosensitive recording paper in the first direction in order to perform recording of said second thermosensitive coloring layer with said thermal head;
s seventh step for feeding said thermosensitive recording paper in the second direction in order to fix said second thermosensitive coloring layer with said second fixing unit;
an eighth step for stopping said thermosensitive recording paper in a state that said second fixing unit continues fixation, when said end portion of said record area has confronted said second fixing unit;
a ninth step for feeding said thermosensitive recording paper in the first direction when a radiation amount of the electromagnetic rays of said end portion has become equal to that of a portion of the thermosensitive recording paper, which has already passed said second fixing unit;
a tenth step for feeding said thermosensitive recording paper in the second direction; and
an eleventh step for feeding said thermosensitive recording paper in the first direction in order to perform recording of said third thermosensitive coloring layer with said thermal head.

8. A thermal printer according to claim 6, wherein said first through third thermosensitive coloring layers are a yellow thermosensitive coloring layer, a magenta thermosensitive coloring layer and a cyan thermosensitive coloring layer.

9. A thermal printer according to claim 5, wherein said fixing unit comprises a rod-shaped ultraviolet lamp and a reflector covering said ultraviolet lamp and having a prescribed open area, a center position of said ultraviolet lamp is biased toward said upstream side from a center position of said open area of said reflector.

10. A thermal printer according to claim 5, wherein said fixing unit comprises a plurality of light-emitting elements arranged in matrix, said light-emitting elements having higher density at said upstream side rather than said downstream side.
